(19) United States
(12) Patent Application Publication
(10) Pub. No.: US 2015/0341978 A1
(43) Pub. Date: Nov. 26, 2015

(54) Increasing DRX Cycle Length by Adding Higher Order Bits for System Frame Number SFN Outside of SFN Parameter

(71) Applicant: TELEFONAKTIEBOLAGET L M ERICSSON (PUBL), Stockholm (SE)

(72) Inventor: Johan Rune, Lidingö (SE)

(21) Appl. No.: 14/653,124

(22) PCT Filed: Dec. 19, 2012
(86) PCT No.: PCT/SE2012/051427

§ 371 Date: Jun. 17, 2015

(51) Int. Cl. H04W 76/04; H04W 68/00; H04W 48/12

(52) U.S. Cl. CPC H04W 76/048; H04W 48/12; H04W 68/005; H04W 88/08

(57) ABSTRACT

The applications relates to configuring a Discontinuous Reception DRX cycle Paging DRX cycle and connected mode DRX cycle are both limited by the current SFN cycle length., i.e. because the system frame number in the Master Information Block consists of only 8 bits the maximum SFN is 1023. Both DRX cycles can not be longer than the SFN cycle. The problem is solved in that the SFN parameter is extended. The extended SFN range and cycle enables an extension of both the paging DRX cycle and the long connected mode DRX cycle. As the bits in the MIB are costly, because they are frequently transmitted, using robust and thus costly coding, the proposed solution avoids adding bits to the SFN parameter in the MIB. Furthermore, extending the current SFN parameter in a separate parameter, backwards compatibility is maintained because a legacy user equipment will only read the original SFN parameter and ignore the new separate parameter. A suitable size of this new separate parameter, also referred to as SFN extension parameter, would be 10 bits, yielding a SFN cycle of almost 3 hours (2˜20*10 ms=174 minutes). A radio base station (12) controlling a cell (11) serving the user equipment (10) transmits system information comprising the above mentioned SFN extension parameter to the user equipment which configures a DRX cycle based now on both, the original SFN and the SFN extension parameter.

### TECHNICAL FIELD

Embodiments herein relate to a radio base station, a user equipment and methods therein. In particular, embodiments herein relate to transmit system information in a cellular radio system.

### BACKGROUND

In a typical radio communications network, wireless terminals, also known as mobile stations and/or user equipments (UEs), communicate via a Radio Access Network (RAN) to one or more core networks. The radio access network covers a geographical area which is divided into cell areas, with each cell area being served by a base station, e.g., a radio base station (RBS), which in some networks may also be called, for example, a “NodeB” (UMTS) or “eNodeB” (LTE). A cell is a geographical area where radio coverage is provided by the radio base station at a base station site or an antenna site in case the antenna and the radio base station are not collocated. Each cell is identified by an identity within the local radio area, which is broadcast in the cell. Another identity identifying the cell uniquely in the whole mobile network is also broadcasted in the cell. The base stations communicate over the air interface operating on radio frequencies with the user equipments within range of the base stations.

In some versions of the RAN, several base stations are typically connected, e.g., by landlines or microwave, to a controller node, such as a radio network controller (RNC) or a base station controller (BSC), which supervises and coordinates various activities of the plural base stations connected thereto. The RNCs are typically connected to one or more core networks.

A Universal Mobile Telecommunications System (UMTS) is a third generation mobile communication system, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipments. In a forum known as the Third Generation Partnership Project (3GPP), telecommunications suppliers propose and agree upon standards for third generation networks and UTRAN specifically, and investigate enhanced data rate and radio capacity.

Specifications for the Evolved Packet System (EPS) have been completed within the 3^{rd} Generation Partnership Project (3GPP) and this work continues in the coming 3GPP releases. The EPS comprises the Evolved Universal Terrestrial Radio Access Network (E-UTRAN), also known as the Long Term Evolution (LTE) radio access, and the Evolved Packet Core (EPC), also known as System Architecture Evolution (SAE) core network. E-UTRAN/LTE is a variant of a 3GPP radio access technology wherein the radio base station nodes are directly connected to the EPC core network rather than to RNCs. In general, in E-UTRAN/LTE the functions of a RNC are distributed between the radio base stations nodes, e.g., eNodeBs in LTE, and the core network. As such, the radio access network (RAN) of an EPS system has an essentially “flat” architecture comprising radio base station nodes without reporting to RNCs.

A currently popular vision of the future development of the communication in cellular networks comprises huge numbers of small autonomous devices, which typically, more or less infrequently, e.g. once per week to once per minute, transmit and receive only small amounts of data, or are polled for data. These autonomous devices are assumed not to be associated with humans, but are rather sensors or actuators of different kinds, which communicate with application servers, which configure the autonomous devices and receive data from the autonomous devices, within or outside the cellular radio system. Hence, this type of communication is often referred to as Machine-to-Machine (M2M) communication and the autonomous devices may be denoted Machine Devices (MDs). In the 3GPP standardization the corresponding alternative terms are Machine Type Communication (MTC) and MTC devices, with the latter being a subset of the more general term user equipment, UE.

With the nature of MTC devices and assumed typical uses of the MTC devices follow that the MTC devices may often have to be very energy efficient, since external power supplies may not be available and since it is neither practically nor economically feasible to frequently replace or recharge the batteries of the MTC devices.

### SUMMARY

An object of embodiments herein is to provide a mechanism that enables a user equipment to be energy efficient.

According to an aspect of embodiments herein the object is achieved by a method in a user equipment for configuring a Discontinuous Reception cycle at the user equipment in a radio communications network. The radio communications network comprises a radio base station controlling a cell serving the user equipment. The user equipment receives system information from the radio base station. The system information is associated with the cell and comprises a System Frame Number, SFN, parameter, and an SFN extension parameter extending the SFN parameter. The user equipment configures a Discontinuous Reception, DRX, cycle for the user equipment based on the SFN parameter and the SFN extension parameter.

According to another aspect of embodiments herein the object is achieved by a method in a radio base station for transmitting system information in a radio communications network. The radio base station controls a cell in the radio communications network. The system information is associated with the cell and comprises a SFN parameter. The radio base station transmits the system information to one or more user equipments in the cell. The system information further comprises an SFN extension parameter extending the SFN parameter, wherein the SFN parameter and the SFN extension parameter are to be used to configure a Discontinuous Reception cycle at the one or more user equipments.

According to yet another aspect of embodiments herein the object is achieved by a user equipment capable of configuring a DRX cycle at the user equipment, said user equipment is capable of operating in a radio communications network. The radio communications network comprises a radio base station controlling a cell serving the user equipment. The user equipment comprises a receiver configured to receive from the radio base station, system information associated with the cell. The system information comprises a SFN parameter, and an SFN extension parameter extending the SFN parameter. The user equipment further comprises a configuring circuit arranged to configure a DRX cycle for the user equipment based on the SFN parameter and the SFN extension parameter.

According to still another aspect of embodiments herein the object is achieved by a radio base station capable of transmitting system information in a radio communications network. The radio base station is configured to control a cell in the radio communications network. The radio base station comprises a transmitter configured to transmit to one or more user equipments in the cell, system information associated with the cell. The system information comprises a SFN parameter and an SFN extension parameter extending the SFN parameter. The SFN parameter and the SFN extension parameter are to be used to configure a DRX cycle at the one or more user equipments.

Hence, embodiments herein provide mechanism with the advantage of providing low energy consumption in the user equipment by using long, extended, DRX cycles, based on the SFN extension parameter. By extending the SFN parameter the DRX cycles are extended, allowing the user equipment or user equipments to spend most of their idle mode time in an energy-efficient sleep mode with the receiver turned off.

### BRIEF DESCRIPTION OF THE DRAWINGS

Embodiments will now be described in more detail in relation to the enclosed drawings, in which:

FIG. 1 is a schematic overview depicting a radio communications network;

FIG. 2 is a combined flowchart and signalling scheme according to some embodiments herein;

FIG. 3 is a schematic flow chart depicting a method in a user equipment according to embodiments herein;

FIG. 4 is a block diagram depicting a user equipment according to embodiments herein;

FIG. 5 is a schematic flow chart depicting a method in a radio base station according to embodiments herein; and

FIG. 6 is a block diagram depicting a radio base station according to embodiments herein.

### DETAILED DESCRIPTION

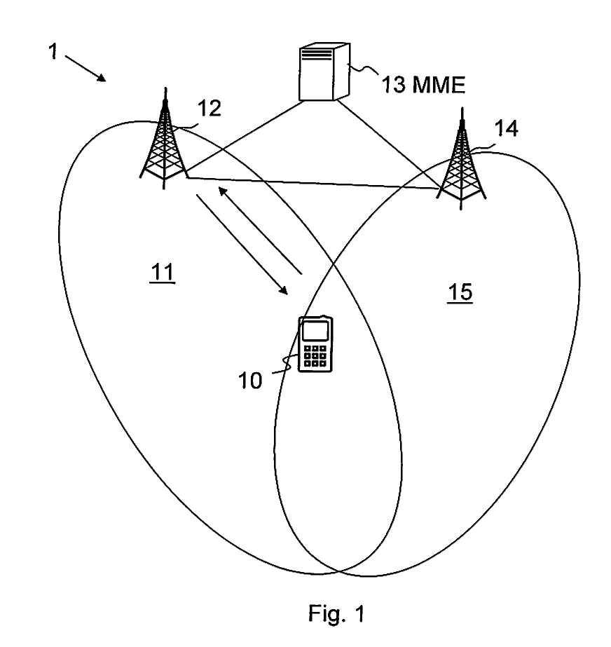

FIG. 1 is a schematic overview depicting a radio communications network 1. The radio communications network 1 comprises one or more RANs and one or more CNs. The radio communications network 1 may use a number of different technologies, such as Long Term Evolution (LTE), LTE-Advanced, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations.

In the radio communications network 1, a user equipment 10, also known as a mobile station and/or a wireless terminal, communicates via a Radio Access Network (RAN) to one or more core networks (CN). It should be understood by the skilled in the art that “user equipment” is a non-limiting term which means any wireless terminal, MTC device or node e.g. Personal Digital Assistant (PDA), laptop, mobile, sensor, relay, mobile tablets or even a small base station communicating within respective cell.

The radio communications network covers a geographical area which is divided into cell areas, e.g. a cell 11 being served by a radio base station 12. The radio base station 12 may also be referred to as a first radio base station. The radio base station 12 may be referred to as e.g. a NodeB, an evolved Node B (eNB, eNode B), a base transceiver station, Access Point Base Station, base station router, or any other network unit capable of communicating with a user equipment within the cell served by ₜhe radio base station depending e.g. on the radio access technology and terminology used. The radio base station 12 may serve one or more cells, such as the cell 11.

A cell is a geographical area where radio coverage is provided by the radio base station equipment at a base station site. The cell definition may also incorporate frequency bands and radio access technology used for transmissions, which means that two different cells may cover the same geographical area but using different frequency bands. Each cell is identified by an identity within the local radio area, which is broadcast in the cell. Another identity identifying the cell 11 uniquely in the whole radio communications network 1 is also broadcasted in the cell 11. The radio base station 12 communicates over the air or radio interface operating on radio frequencies with the user equipment 10 within range of the radio base station 12. The user equipment 10 transmits data over the radio interface to the radio base station 12 in Uplink (UL) transmissions and the radio base station 12 transmits data over an air or radio interface to the user equipment 10 in Downlink (DL) transmissions.

Furthermore, the radio communications network 1 comprises a core network node such as a Mobility Management Entity (MME) 13 for mobility management. Another, different, or second, radio base station 14 is also comprised in the radio communications network 1. The second radio base station 14 provides radio coverage over a second cell 15, another or a different cell, e.g. a cell neighboring to the cell 11.

An interface between the radio base station 12, 14 and the MME 13 is an S1 interface, or more specifically S1-MME which is the control plane part of the S1 interface, and an interface between the radio base station 12 and the second radio base station 14 is an X2 interface.

In some versions of the radio communications network 1, several base stations are typically connected, e.g. by landlines or microwave, to a controller node (not shown), such as a RNC or a BSC, which supervises and coordinates various activities of the plural base stations connected thereto. The RNCs are typically connected to one or more core networks.

According to embodiments herein the radio base station 12 sets and transmits system information to the user equipment 10. The system information comprises a System Frame Number (SFN) parameter and an SFN extension parameter extending the SFN parameter, as will be described below. The SFN parameter and the SFN extension parameter are to be used to configure a Discontinuous Reception (DRX) cycle at the one or more user equipments. By extending the SFN parameter, embodiments herein achieve low energy consumption in the user equipment 10 or user equipments by using long, extended, DRX cycles. This would allow the user equipment 10 or user equipments to spend most of their idle mode time in an energy-efficient sleep mode with the receiver turned off.

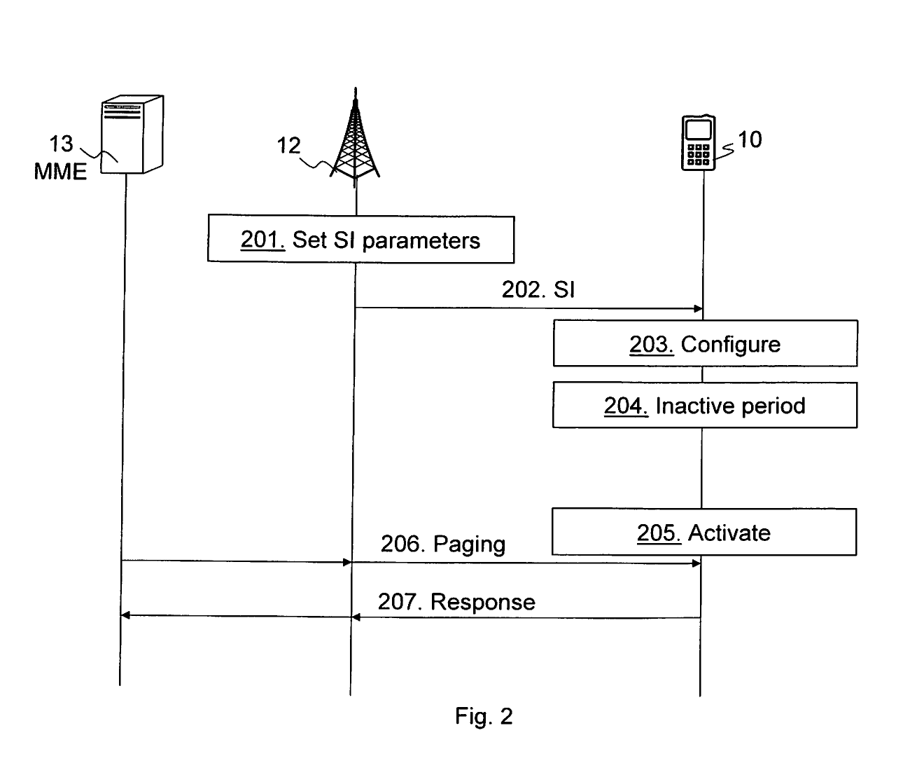

FIG. 2 is a combined flow chart and signalling scheme according to embodiments herein in the radio communications network 1. Embodiments herein are described in terms of EPS/LTE and with the details of this system, but it should be noted that embodiments herein are also applicable to UMTS/WCDMA/HSPA and potentially other cellular systems. Note also that although MTC devices are the primary target to benefit from the advantages of the embodiments herein, embodiments herein may be used in conjunction with any type of user equipment and therefore the term user equipment is used herein.

Action 201. The radio base station 12 may set system information (SI) parameters for the cell 11. The radio base station 12 sets, in embodiments herein, the SFN for the cell 11 in order to enable synchronization within the radio communications network 1. The SFN is configured from an operation and management node or similar. Alternatively, the radio base station 12 may be designed to start the SFN counting at zero, or some other predetermined number, when the radio base station 12 is taken into operation at deployment or after a restart.

Action 202. The radio base station 12 transmits or broadcasts System Information to the user equipment 10 within the cell 11 enabling the user equipment 10 to communicate with the radio base station 12. The system information is transmitted in different blocks of information such as a Master Information Block (MIB), a System Information Block (SIB) in one or more system information messages. The system information comprises the SFN, and the SFN according to embodiments herein comprises an SFN parameter and an SFN extension parameter extending the SFN parameter. Embodiments herein introduce the extension to the current SFN parameter in a separate parameter in another part of the system information than the MIB, thereby maintaining backwards compatibility for legacy user equipments, while avoiding to extend the precious MIB bits. The separate SFN extension parameter may be placed in SIB2, where “SIB” stands for System Information Block and the number indicates the type of SIB, in this case type 2, where the current paging configuration parameters are located. The SFN extension parameter may represent the high order bits while the original SFN parameter would represent the low order bits of a total SFN.

Action 203. The user equipment 10 receives the broadcast and configures the DRX cycle for the user equipment 10 based on the SFN parameter and the SFN extension parameter. Thus, as the SFN is extended, the user equipment 10 may prolong or extend an inactive period of the DRX cycle at the user equipment 10 leading to a reduced energy consumption at the user equipment 10. A suitable size of the SFN extension parameter may be 10 bits, yielding the total SFN cycle of almost 3 hours. However, this size of the SFN extension parameter may be rather arbitrary, which does not exclude that other, possibly much longer SFN extensions are considered, e.g. a 16 bit extension, resulting in a total DRX cycle of slightly more than a week.

Action 204. The user equipment 10 may then go into an inactive period of the DRX cycle according the configuration based on the SFN parameter and the SFN extension parameter. The split SFN, i.e. using the SFN parameter and the SFN extension parameter, allows the user equipment 10 when being a legacy user equipment to read only the part that represents the original SFN parameter and to ignore the new extension part. The user equipment 10 would then perceive a legacy SFN cycle of 1024 radio frames and its SFN related procedures and algorithms would thus be unaffected.

The user equipment 10, when being a non-legacy user equipment, on the other hand, may choose to read only the original SFN parameter or both the original SFN parameter and the SFN extension parameter. Retrieving the SFN extension parameter would be needed only if the user equipment 10 is using an extended paging DRX cycle or an extended long connected mode DRX cycle, i.e. a DRX cycle greater than 256 radio frames.

Action 205. The user equipment 10 may furthermore become active after the inactive period enabling a paging of the user equipment 10.

Action 206. The MME 13 pages the user equipment 10 within the cell 11, i.e. the MME 13 orders the radio base station 12 to page the user equipment 10 and the radio base station 12 sends a paging message to the user equipment 10.

Action 207. The user equipment 10 responds to the received paging message back to the radio base station 12, which forwards the response to the MME 13.

In the current EPS/LTE standard the paging DRX cycle, i.e. its length and its phase in relation to the SFN cycle, is defined by the paging configuration parameters T and nB together with International Mobile Subscriber Identity (IMSI) modulo (MOD) 1024.

The T parameter is defined as the minimum of the defaulₜPagingCycle Information Element (IE), which is broadcast in SIB2 of the system information, and a possible preconfigured UE specific cycle length of a paging DRX cycle. The broadcast of Paging messages by the radio base station 12 is done only in certain sub-frames, so called Paging Occasions (PO), of certain Radio Frames, so called Paging Frames (PFs). Configuration of PFs and POs are done in the radio base station 12 by the parameters nB, IMSI MOD 1024 and the minimum of the defaultPagingCycle and an optional UE specific cycle length of the paging DRX cycle. These parameters are used by the radio base station 12 and the user equipment 10 in calculations of the occurrences of POs in the time domain, in terms of which frames—and which subframes within the frames—that POs occur, using an algorithm defined in 3GPP Technical Specification 36.304 V11.1.0 “3rd Generation Partnership Project; Technical Specification Group Radio Access Network; Evolved Universal Terrestrial Radio Access (E-UTRA); User Equipment (UE) procedures in idle mode (Release 11)”.

The nB parameter is broadcast together with the defaultPagingCycle IE in SIB2 of the system information. An IMSI of the user equipment 10 is stored in a Universal Subscriber Identity Module (USIM) on a Universal Integrated Circuit Card (UICC) in the user equipment 10 as well as in the MME 13 in which the user equipment 10 is registered. When sending an S1AP PAGING message to the radio base station 12 to instruct the radio base station 12 to page the user equipment 10, the MME 13 includes IMSI MOD 1024 in a UE identity index value IE and a possible UE specific cycle length of the paging DRX cycle in the Paging DRX IE.

It should here be understood that a paging DRX cycle is divided into a sleep period, also referred to as the inactive period, and an active period, wherein the active period may be a potential paging occasion. The user equipment 10 may be configured with DRX also in connected mode. In connected mode DRX means that the user equipment 10 monitors the PDCCH during the active part(s) of a DRX cycle, while spending the remaining part of the DRX cycle in a DRX sleep mode. The DRX behavior in connected mode is governed by a number of UE specific parameters that are configured by the radio base station 12 via Radio Resource Control (RRC) signaling, e.g. an

RRCConnectionReconfiguration RRC message. These parameters include not only cycle definitions, but also timers governing the user equipment's behaviour in conjunction with transmissions. There are actually two types of DRX cycles for connected mode DRX, a long cycle and an optional short cycle, wherein the short cycle may be used at the end of each active period in the long cycle. Of most interest in the context of this disclosure is the length of the long DRX cycle. This is defined in relation to the SFN and the subframes within a radio frame, such that an active period starts, which is also the start of the long DRX cycle, when [(SFN×10)+subframe number] modulo (longDRX−Cycle)=drxStartOffset.

In prior art the maximum paging DRX cycle length and the long DRX cycle for connected mode DRX are both 2.56 seconds in LTE, i.e. 2560 subframes of one ms each, which is one fourth of the SFN cycle which is 10.24 seconds, i.e. 1024 radio frames of ten ms each. A SFN is associated with every radio frame in LTE. A radio frame is 10 ms long and consists of ten subframes of one ms each. The present SFN parameter wraps around every 10.24 seconds, i.e. every 1024 frames, which is thus an SFN cycle. The SFN parameter is included in the most basic and most frequently broadcast part of the system information, i.e. in the MIB. The MIB is broadcast on the Broadcast Control Channel (BCCH) every tenth ms. Four consecutive MIB transmissions are repetitions and may be combined to improve the chances of correct reception and decoding during poor channel conditions. The SFN parameter in the MIB consists of eight bits. The transmission time of the MIB provides another two “implicit bits”, yielding an SFN number of 10 bits, i.e. 0-1023. The MIB is transmitted with a 40 ms schedule with repetitions every tenth ms, in subframe 0 in every frame. During the four MIB transmissions within a 40 ms period the SFN parameter in the MIB is fixed. Hence, the granularity of the SFN parameter in the MIB is 40 ms, whereas the MIB repetition number signifies the additional two bits. The MIB repetition number is not explicitly indicated, but has to be derived from receiving several MIB transmissions and detecting when the SFN parameter in the MIB changes between two MIB transmissions.

The paging configuration information in the system information is sent in SIB2. SIB2 is transmitted on the Physical Downlink—Shared Channel (PD-SCH) within a periodically reoccurring time window, whose length and periodicity are configurable and defined in System information Block type 1 (SIB1). The window length is configurable between 1 ms and 40 ms and the periodicity ranges from 8 to 512 radio frames (i.e. 80-5120 ms). The transmission schedule of SIB2 is indicated in SIB1, which is transmitted in the PD-SCH five subframes, i.e. 5 ms, after every second MIB repetition, i.e. subframe #5 of every radio frame for which SFN mod 2=0

Thus, to retrieve the paging configuration information the user equipment 10 first has to retrieve the MIB, then retrieve the SIB1 and finally retrieve the SIB2, which comprises the actual paging configuration information. As mentioned above, the SIB1 comprises the transmission schedule for the SIB2. Furthermore, the transmissions of the SIB2, as well as the exact transmission resources being used, are indicated on the Physical Downlink Control Channel (PDCCH), like any other PD-SCH transmission, and addressed to a System Information—Radio Network Temporary Identifier (SI-RNTI).

The prior art paging configuration parameters and algorithms are defined in relation to the 1024 radio frames, i.e. 10.24 seconds, long SFN cycle and the maximum paging DRX cycle length is only 2.56 seconds. Embodiments herein provide really energy efficient paging DRX cycles for e.g. MTC devices that are much longer, e.g. several minutes or even hours. Thus, embodiments herein avoid the limitation of the SFN cycle length set by the current mechanisms in prior art systems. Similarly, the long cycle for connected mode DRX is currently limited to 2.56 seconds. Embodiments herein allow for energy saving purposes configuration of much longer cycles also for DRX in connected mode. The long connected mode DRX cycle could rather straightforwardly be extended to the total SFN cycle by extending the ranges of the RRC parameters governing the length and start offset of the long connected mode DRX cycle, but, like the paging DRX cycle, it is limited by the SFN cycle length.

Thus, embodiments herein provide an extended SFN range and cycle enabling the extensions of both the paging DRX cycle and the long connected mode DRX cycle.

Embodiments herein extend the range of the SFN and thus enabling extension of the DRX cycle in an efficient manner. Embodiments herein change a fundamental system parameter like the SFN without serious implications on backwards compatibility. That is, legacy user equipments are able to access the system, even if the SFN is modified by extending its range. As the bits in the MIB are costly, because they are frequently transmitted, using robust and thus costly coding, embodiments herein avoid adding bits to the SFN parameters in the MIB thus avoiding undesirable consequences resource-wise.

Embodiments herein also comprise mechanisms for distribution of SFN information and radio frame and/or subframe phase differences between base stations, e.g. based on measurement data initially retrieved from user equipments such as the user equipment 10 during Automatic Neighbor Relation (ANR) procedures. Redistribution of this refined information to user equipments such as the user equipment 10 may facilitate paging occasion derivation and really energy efficient paging DRX implementations in user equipments such as the user equipment 10. The user equipment 10 does not have to retrieve the SFN extension parameter often. Essentially, once in every cell should be sufficient. After that the user equipment 10 may keep track of the SFN extension parameter through dead reckoning, i.e. based on its internal clock. Since the value of the SFN extension parameter may change only once every 10.24 seconds, even a quite inaccurate internal clock is enough to keep track of the SFN extension parameter for a long time. Hence, the user equipment 10 may even keep track of the SFN extension parameter of several cells, which it has visited during a more or less extensive period. The length of this dead reckoning period for previously visited cells may be limited by the accuracy of the internal clock, but if this accuracy is rather high, then one may still choose to use a stricter limit of the dead reckoning period for previously visited cells, because of the minor risk that a radio base station controlling the previously visited cell has been restarted and thus has had its SFN, including SFN extension, value reset.

The times the user equipment 10 needs to retrieve the SFN extension may be decreased even further than once per cell, provided that the user equipment 10 in the cell 11 may receive information of the SFN extension parameter. The user equipment 10 may further receive total SFN values, of neighboring cells, such as the second cell 15, or even all cells in a certain area, such as a Tracking Area (TA) or a Multicast-Broadcast Single Frequency Network (MBSFN) area or a cluster of cells being served by the same radio base station. Such information may be provided in the system information together with the SFN extension or it may be provided through dedicated RRC signaling. According to some embodiments when the user equipment 10 enters a cell in a new TA, and thus contacts the radio communications network 1 for a TA Update provided that a Tracking Area Identity (TAI) of the TA is not included in the current TAI list of the user equipment 10, the radio base station 12 may use dedicated RRC signaling to inform the user equipment 10 of the SFN extension parameter, or total SFN value, in all the cells of the TA. A suitable RRC message for this purpose may be the RRCConnectionSetup message.

To maintain such a scheme the SFN extension parameters, or total SFN values, of the cells in a TA have to be distributed to all the radio base stations such as the radio base station 12 serving at least one cell in the TA. This may be handled autonomously by the radio base stations, e.g. across the X2 interface between neighbor radio base stations 12,14, possibly complemented by S1AP signaling via the MME 13, wherein the information may be relayed un-interpreted by the MME 13. For instance, initial SFN extension parameter, or total SFN, information may be exchanged during the X2 establishment procedure. In order for the SFN extension parameter, or total SFN, of all cells in the TA to be known by all the radio base stations in the TA, the radio base station 12 may not only transfer its own SFN extension parameter, or total SFN, but the SFN extension parameter, or total SFN, of all the cells in the TA for which it knows the SFN extension parameter, or total SFN. This principle ensures that the SFN extension parameter, or total SFN, of all cells in the TA will be known by all the radio base stations in the TA. The radio base station 12 and other radio base stations may maintain the accuracy of this information by updating each other if the SFN extension parameter, or total SFN, of the cell 11 for some reason changes unpredictably, e.g. due to a radio base station restart, or at regular intervals which may be short enough to avoid that the radio base station 12 gets an incorrect perception of the SFN extension parameter, or total SFN, of another cell due to clock drifts between the radio base stations 12,14.

To achieve higher accuracy in the distributed SFN information it may be based on leveraging the ANR mechanism, i.e. that radio base stations utilize connected user equipments to discover neighbor relations between cells. When the user equipment 10 is involved in the ANR procedure and reads, at least parts of, the system information of a discovered neighbor cell, such as the second cell 15, and reports information such as the E-UTRAN Cell Global Identifier (ECGI) and the Physical Cell Identifier (PCI) to the radio base station 12, it may also report the SFN extension parameter, or total SFN, of the discovered second cell 15. Furthermore, the user equipment 10 may provide detailed timing information about the phase difference between the radio frames and/or subframes of the second cell 15 and the cell 11 it is reporting in. When this extended, and more accurate information about SFN extension parameter, or total SFN, is redistributed among radio base stations via the X2, and/or the S1, interface, the additional timing information, i.e. relative radio frame and/or subframe phase differences, is included. Thus, the radio base stations 12, 14 may derive the corresponding phase differences to other, non-neighboring cells in the TA. By adding phase differences received from a neighbor cell to the phase difference(s) between the reporting radio base station, e.g. the radio base station 12, and the receiving radio base station, e.g. the second radio base station 14, the 25 receiving radio base station may derive the accurate phase difference(s) to the non-neighbor cell. In order to keep such higher accuracy SFN information up to date, it would be possible to use the ANR principle of the user equipment 10 reporting periodically with the purpose of retrieving the SFN information of a neighbor cell, i.e. decoupled from the original purpose of the ANR reporting mechanism, which is to discover new neighbor cells and enable establishment of neighbor relations.

As an example of the above described combination of ANR and redistribution among radio base stations, such as the radio base stations 12 and 14, consider radio base stations A, B and C, for simplicity having one cell each, the number of cells per radio base station does not matter since all cells of a radio base station can be assumed to have synchronized SFNs. Radio base station A and radio base station B are neighbors and radio base station B and radio base station C are neighbors, but radio base station A and radio base station C are not neighbors. The radio base stations first learns the phase difference(s) to their neighbors through the extended ANR mechanism, i.e. a user equipment reports the phase difference(s) between radio base station B and radio base station A to radio base station A; a user equipment reports the phase difference(s) between radio base station A and radio base station B to radio base station B; a user equipment reports the phase difference(s) between radio base station C and radio base station B to radio base station B; and a user equipment reports the phase difference(s) between radio base station B and radio base station C to radio base station C. Then radio base station B reports the received phase difference(s) between radio base station C and radio base station B to radio base station A. By adding this/these phase difference(s) received from radio base station B, i.e. the phase difference(s) between radio base station C and radio base station B, to the phase difference(s) between radio base station B and radio base station A previously reported by the user equipment, radio base station A may calculate the complete phase difference(s) between radio base station C and radio base station A. Through the same principle radio base station C will be able to calculate the phase difference(s) between radio base station A and radio base station C.

As mentioned above, the phase difference information enables the radio base stations to even more accurately keep track of the SFN extension parameters or total SFN of other cells. This phase difference information may also be conveyed to the user equipments together with the SFN extension parameter, or total SFN, of other cells, as described above.

Knowing the SFN extension parameters or total SFN and accurate radio frame and/or subframe phase difference information of all cells in a TA may facilitate efficiently energy saving paging DRX implementations in user equipments, e.g. by facilitating derivation of the paging occasions or start of active periods of a connected mode DRX cycle in other cells.

It should also be noted that the illustrated examples herein are describe in perspective of an implementation in an LTE network but embodiments herein may also be implemented in e.g. a WCDMA network. The way SFN is broadcast in WCDMA is different from LTE. Instead of including the SFN in the MIB, the SFN, or rather the SFN minus its least significant bit, denoted “SFNprime”, is included in the SYSTEM INFORMATION message, which is used to broadcast the MIB as well as all SIBs. The MIB/SIB information is created in an RNC and transferred to a radio base station, a NodeB. The radio base station broadcasts a SYSTEM INFORMATION message every 20 ms, including MIB/SIB information received from the RNC, which information is transparent for the RBS. Each SYSTEM INFORMATION message comprises one out of a set of possible combinations of MIB/SIB information, wherein MIB/SIB information in such a combination may represent a complete MIB/SIB or segments of MIB/SIB. That is, the SFN is not actually included in any MIB or SIB, but it is broadcast, in the form of the SFNprime parameter, in conjunction with every broadcast of MIB/SIB information. In addition, the paging information is not included in SIB2 in WCDMA, but in SIB1 and SIB5 or SIB5bis.

Hence, when embodiments herein are applied to WCDMA the existing SFN parameter would be kept and broadcast in the manner used today, while the SFN extension parameter would be included in one of the SIBs, e.g. SIB1, SIB5 or SIB5bis. Alternatively, the SFN extension parameter may be included in the SYSTEM INFORMATION message, although still as a parameter that is separate from the regular SFN parameter, i.e. the SFNprime, in the SYSTEM INFORMATION message. Since the SFN extension parameter does not have to be transmitted as frequently as the regular SFN, or SFNprime parameter, the SFN extension parameter may not have to be included in every SYSTEM INFORMATION message. For instance, it may suffice to include the SFN extension parameter in every 4^{th}, 8^{th}, 16^{th} or 32^{nd} SYSTEM INFORMATION message, translating into broadcast periodicities of 80, 160, 320 or 640 milliseconds. Irrespective of the chosen broadcast periodicity, the SYSTEM INFORMATION messages to include the SFN extension parameter in may be chosen so that the SFN extension parameter is included in the SYSTEM INFORMATION message every time the regular SFN wraps around, i.e. in every SYSTEM INFORMATION message that contains an SFNprime parameter that is equal to zero.

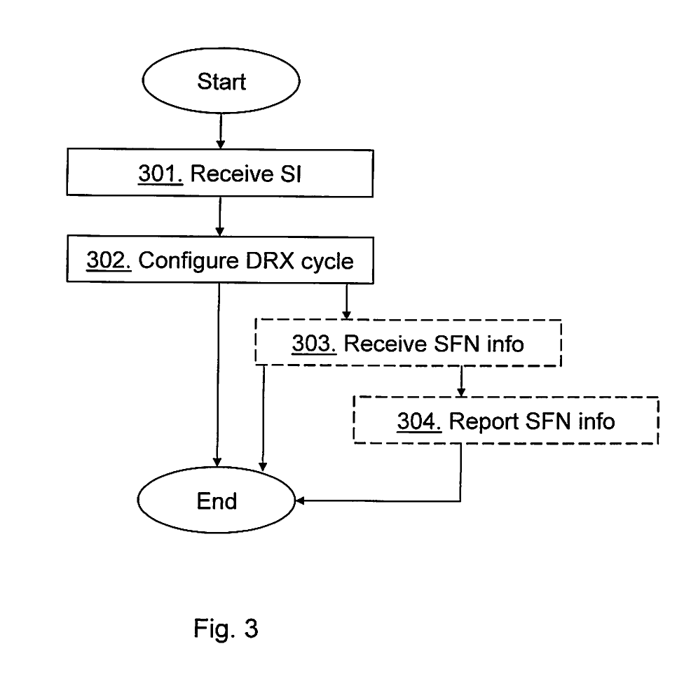

The method actions in the user equipment 10 for configuring the DRX cycle at the user equipment 10 in the radio communications network 1 according to some embodiments will now be described with reference to a flowchart depicted in FIG. 3. The actions do not have to be taken in the order stated below, but may be taken in any suitable order. The radio communications network 1 comprises the radio base station 12 controlling the cell 11 serving the user equipment 10. Actions performed in some embodiments are marked as dashed boxes.

Action 301. The user equipment 10 receives system information from the radio base station 12. The system information is associated with the cell 11 and comprises the SFN parameter and the SFN extension parameter extending the SFN parameter. The received system information may comprise a MIB. The SFN parameter is comprised in the MIB and the SFN extension parameter is comprised in a block in the system information other than the MIB. The received system information may be comprised in one or more SYSTEM INFORMATION messages, and the SFN extension parameter may be comprised in each, a subset or one of the one or more SYSTEM INFORMATION messages. Thus, embodiments herein achieve the desired extension of the range and cycle of the SFN without using more of the most costly and precious bits of the SI, i.e. the MIB bits. The SFN extension parameter may be comprised in a System Information Block type 2, SIB2, of the system information, which SIB2 comprises a paging configuration parameter. Alternatively, the SFN extension parameter may be comprised in a System Information Block type 5, SIB5, or System Information Block type 5bis, SIB5bis. According to some embodiments the SFN extension parameter represents high order bits while the SFN parameter represents low order bits of the total SFN. Hence, the desired extension of the range and cycle of the SFN may be achieved in a backwards compatible way, thereby avoiding the typically inherent compatibility problem associated with modifications of fundamental system parameters. Furthermore, legacy user equipments may ignore the SFN extension and non-legacy user equipments may retrieve the SFN extension very sparsely and otherwise ignore it, thus improving both resource efficiency and performance.

Action 302. The user equipment 10 configures the DRX cycle for the user equipment 10 based on the SFN parameter and the SFN extension parameter. In some embodiments, the user equipment 10 configures an inactive period of a paging DRX cycle and/or a cycle length of a connected mode DRX cycle. Thus, embodiments herein facilitate introduction of really energy efficient extended paging DRX cycles and extended long connected mode DRX cycles.

Action 303. In some embodiments, the user equipment 10 receives SFN information, such as the SFN parameter and/or the SFN extension parameter, of the second cell 15 in the radio communications network 1 from the radio base station 12 or the second radio base station 14. Hence, embodiments herein distribute SFN and timing information between radio base stations for further delivery to user equipments, thereby facilitating resource efficiency and energy efficient extended paging DRX and connected mode DRX implementations.

Action 304. Additionally, the user equipment 10 may report the SFN information of the second cell 15 to the radio base station 12.

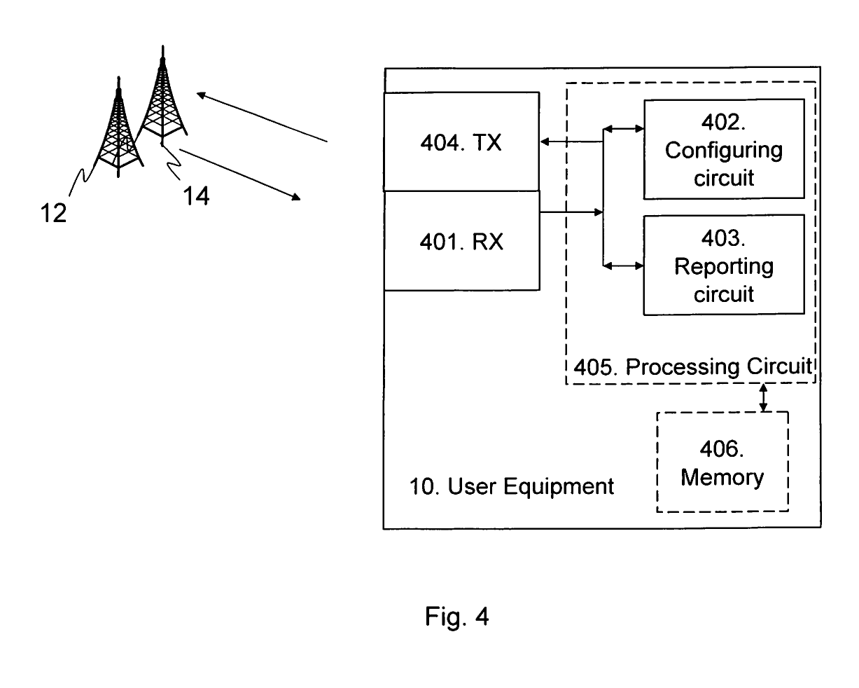

FIG. 4 is a block diagram depicting the user equipment 10 capable of configuring the DRX cycle at the user equipment 10, and said user equipment 10 is capable of operating in the radio communications network 1. As stated above, the radio communications network 1 comprises the radio base station 12 controlling the cell 11 serving the user equipment 10.

The user equipment 10 comprises a receiver (RX) 401 configured to receive from the radio base station 12. The system information is associated with the cell 11 and comprises the SFN parameter and the SFN extension parameter extending the SFN parameter. The received system information may comprise the MIB, and the SFN parameter may be comprised in the MIB as stated above. The SFN extension parameter is comprised in a block in the system information other than the MIB. The received system information may be comprised in one or more SYSTEM INFORMATION messages, and the SFN extension parameter may be comprised in each, a subset or one of the one or more SYSTEM INFORMATION messages. The SFN extension parameter may be comprised in the SIB2 of the system information, which SIB2 comprises one or more paging configuration parameters, or, as stated above, in SIB5 or SIB5bis. The SFN extension parameter represents high order bits while the SFN parameter represents low order bits of the total SFN. The receiver 401 may further be configured to receive SFN information of the second cell 15 in the radio communications network 1 from the radio base station 12 or the second radio base station 14.

The user equipment 10 further comprises a configuring circuit 402 arranged to configure the DRX cycle for the user equipment 10 based on the SFN parameter and the SFN extension parameter. The configuring circuit 402 may be arranged to configure an inactive period of a paging DRX cycle and/or a cycle length of a connected mode DRX cycle.

The user equipment 10 may further comprise a reporting circuit 403 configured to report the SFN information of the second cell 15 to the radio base station 12. This may be reported through a transmitter (TX) 404 arranged at the user equipment 10. The receiver 401 and the transmitter 404 may be combined into a transceiver.

The embodiments herein for configuring the DRX cycle at the user equipment 10 may be implemented through one or more processors, such as a processing circuit 405 in the user equipment 10 depicted in FIG. 4, together with computer program code for performing the functions and/or method steps of the embodiments herein. The program code mentioned above may also be provided as a computer program product, for instance in the form of a data carrier carrying computer program code for performing embodiments herein when being loaded into the user equipment 10. One such carrier may be in the form of a CD ROM disc. It is however feasible with other data carriers such as a memory stick. The computer program code may furthermore be provided as pure program code on a server and downloaded to the user equipment 10.

The user equipment 10 may further comprise a memory 406. The memory 406 may comprise one or more memory units and may be used to store for example data such as SFN information, system information, DRX information, timers, application to perform the methods herein when being executed on the user equipment 10 or similar.

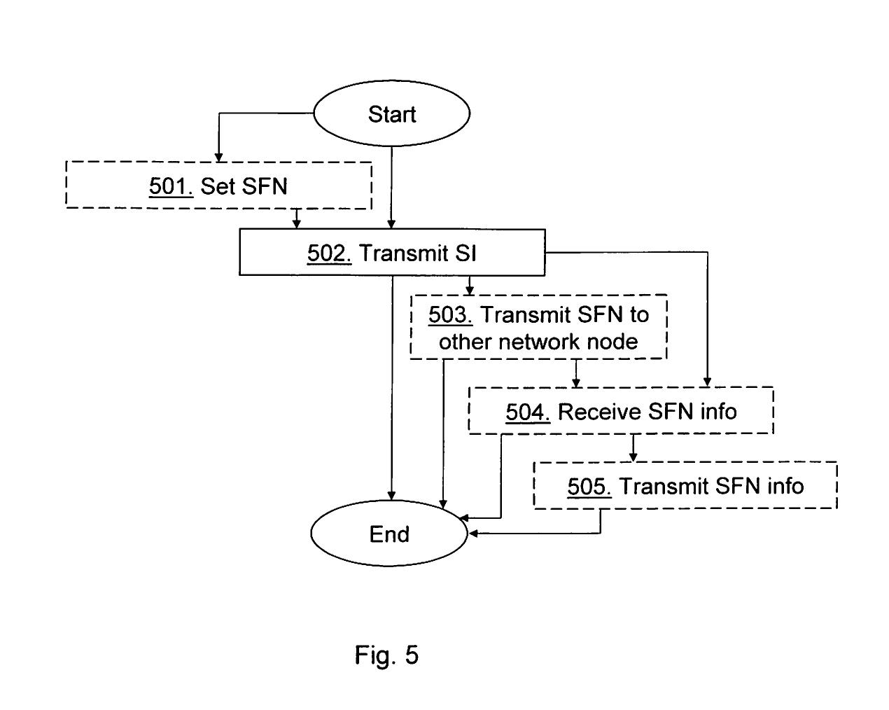

The method actions in the radio base station 12 for transmitting system information in a radio communications network 1 according to some embodiments will now be described with reference to a flowchart depicted in FIG. 5. The actions do not have to be taken in the order stated below, but may be taken in any suitable order. The radio base station 12 controls the cell 11. The radio base station 12 may control more than one cell. Actions performed in some embodiments are marked as dashed boxes.

Action 501. The radio base station 12 may set the SFN for the cell 11 according to preconfigured control data. The SFN may be configured from an operation and management node or similar. Alternatively, the radio base station 12 may be designed to start the SFN counting at zero, or some other predetermined number, when the radio base station 12 is taken into operation at deployment or after a restart.

Action 502. The radio base station transmits system information associated with the cell 11 to one or more user equipments, such as the user equipment 10, in the cell 11. The system information comprises the SFN parameter and the SFN extension parameter extending the SFN parameter. The SFN parameter and the SFN extension parameter are to be used to configure the DRX cycle at the one or more user equipments. The DRX cycle may comprise an inactive period of the paging DRX cycle and/or a cycle length of the connected mode DRX cycle. The system information comprises the MIB and the SFN parameter is comprised in the MIB. The SFN extension parameter is comprised in a block of bits in the system information other than the MIB. The system information may be comprised in one or more SYSTEM INFORMATION messages, and the SFN extension parameter may be comprised in each, a subset or one of the one or more SYSTEM INFORMATION messages. The SFN extension parameter may be comprised in the SIB2, SIB5 or SIB5bis of the system information. The SIB2 comprises at least one paging configuration parameter. The SFN extension parameter may represent high order bits while the SFN parameter may represent low order bits of the total SFN or full SFN.

Action 503. The radio base station 12 may transmit at least one of the SFN parameter and the SFN extension parameter to the second radio base station 14 or another node in the radio communications network 1.

Action 504. The radio base station 12 may receive SFN information of the second cell 15 in the radio communications network 1 from the second radio base station 14, another network node, and/or one or more user equipments, which may be the user equipment 10 or a different user equipment, within the cell 11. SFN information may comprise SFN parameter, SFN extension parameter or a total SFN value of the second cell 15.

Action 505. The radio base station 12 may transmit the received SFN information of the second cell 15 to the one or more user equipments in the cell 11, the second radio base station 14 and/or another network node in the radio communications network 1. The radio base station 12 may broadcast the system information.

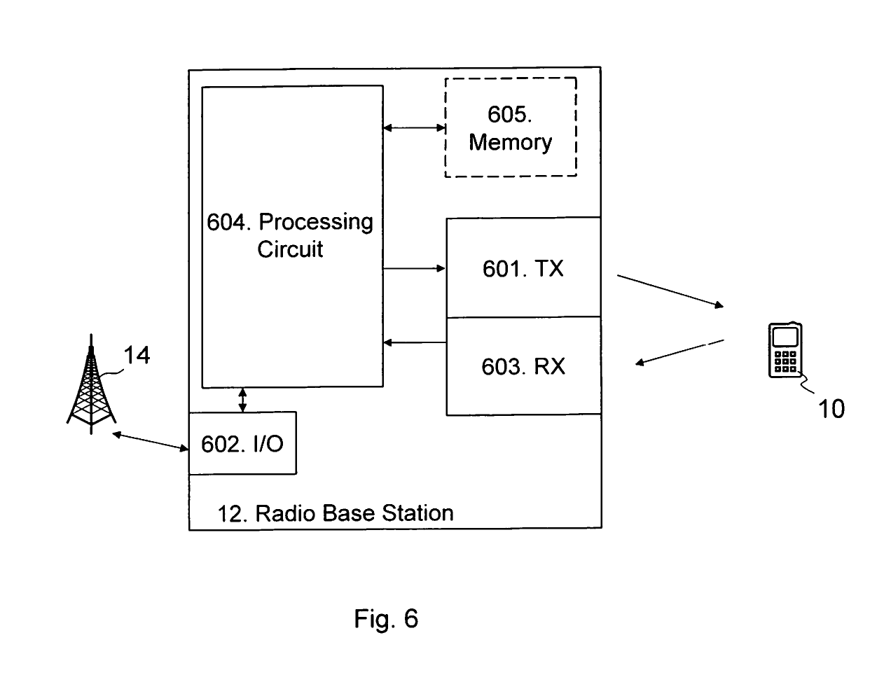

FIG. 6 is a block diagram depicting the radio base station 12 capable of transmitting system information in a radio communications network 1. The radio base station 12 is configured to control the cell 11 in the radio communications network 1.

The radio base station 12 comprises a transmitter (TX) 601 configured to transmit to one or more user equipments, i.e. the user equipment 10, in the cell 11, system information associated with the cell 11. The system information comprises the SFN parameter and the SFN extension parameter extending the SFN parameter. The SFN parameter and the SFN extension parameter are to be used to configure the DRX cycle at the one or more user equipments. The DRX cycle may comprise an inactive period of the paging DRX cycle and/or a cycle length of the connected mode DRX cycle. The SFN parameter may be comprised in the MIB of the system information. The SFN extension parameter may be comprised in a block of bits in the system information other than the MIB. The system information may be comprised in one or more SYSTEM INFORMATION messages, and the SFN extension parameter may be comprised in each, a subset or one of the one or more SYSTEM INFORMATION messages. In some embodiments the SFN extension parameter is comprised in the SIB2, SIB5, or SIB5bis of the system information. The SIB2 comprises the paging configuration parameter or parameters. The SFN extension parameter may represent high order bits while the SFN parameter may represent low order bits of a total SFN.

The radio base station 12 may further comprise an input/output interface (I/O) 602 configured to transmit at least one of the SFN parameter and the SFN extension parameter to the second radio base station 14 in the radio communications network 1.

The radio base station 12 may further comprise a receiver (RX) 603 configured to receive from one or more user equipment within the cell 11, SFN information of the second cell 15 in the radio communications network 1; and/or the I/O 602 being configured to receive from the second radio base station 14 or another network node, SFN information of the second cell 15 in the radio communications network 1.

The transmitter 601 may further be configured to transmit the SFN information of the second cell 15 to the one or more user equipments in the cell 11, and/or the I/O 602 may be configured to transmit the SFN information of the second cell 15 to the second radio base station 14 or another network node in the radio communications network 1. The transmitter 601 and the receiver 603 may be combined into a transceiver.

The radio base station 12 may further comprise a processing circuit 604 configured to set the SFN parameter and the SFN extension parameter for the cell 11.

The processing circuit 604 in the radio base station 12 may together with computer program code perform the functions and/or method actions of the embodiments herein. The program code mentioned above may also be provided as a computer program product, for instance in the form of a data carrier carrying computer program code for performing embodiments herein when being loaded into the radio base station 12. One such carrier may be in the form of a CD ROM disc. It is however feasible with other data carriers such as a memory stick. The computer program code may furthermore be provided as pure program code on a server and downloaded to the radio base station 12.

The radio base station 12 may further comprise a memory 605. The memory 605 may comprise one or more memory units and may be used to store for example data such as SFN information, system information, DRX information, timers, application to perform the methods herein when being executed on the radio base station 12 or similar.

Those skilled in the art will also appreciate that the various “circuits” described may refer to a combination of analog and digital circuits, and/or one or more processors configured with software and/or firmware, e.g. stored in memory, that, when executed by the one or more processors, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments herein being defined by the following claims.

1-36. (canceled)

37. A method in a user equipment for configuring a Discontinuous Reception cycle (DRX) at the user equipment in a radio communications network, which radio communications network comprises a radio base station controlling a cell serving the user equipment, the method comprising:
receiving system information from the radio base station, which system information associated with the cell comprises a System Frame Number (SFN) parameter and an SFN extension parameter extending the SFN parameter; and
configuring a DRX cycle for the user equipment based on the SFN parameter and the SFN extension parameter.

38. The method of claim 37, wherein the configuring comprises configuring an inactive period of a paging DRX cycle and/or a cycle length of a connected mode DRX cycle.

39. The method of claim 37, wherein the received system information comprises a Master Information Block (MIB) and wherein the SFN parameter is comprised in the MIB and the SFN extension parameter is comprised in a block in the system information other than the MIB.

40. The method of claim 37, wherein the received system information is comprised in one or more SYSTEM INFORMATION messages, and the SFN extension parameter is comprised in each, a subset, or one of the one or more SYSTEM INFORMATION messages.

41. The method of claim 37, wherein the SFN extension parameter is comprised in a System Information Block type 2 (SIB2) of the system information, which SIB2 comprises a paging configuration parameter; or in System Information Block type 5 or System Information Block type 5bis .

42. The method of claim 37, wherein the SFN extension parameter represents high order bits while the SFN parameter represents low order bits of a total SFN.

43. The method of claim 37, further comprising receiving SFN information of a second cell in the radio communications network from the radio base station or a second radio base station.

44. The method of claim 43, further comprising reporting the SFN information of the second cell to the radio base station.

45. A method in a radio base station for transmitting system information in a radio communications network, which radio base station controls a cell in the radio communications network, the method comprising:
transmitting system information associated with the cell to one or more user equipments in the cell, which system information comprises a System Frame Number (SFN) parameter and an SFN extension parameter extending the SFN parameter, wherein the SFN parameter and the SFN extension parameter are to be used to configure a Discontinuous Reception (DRX) cycle at the one or more user equipments.

46. The method of claim 45, wherein the DRX cycle comprises an inactive period of a paging DRX cycle and/or a cycle length of a connected mode DRX cycle.

47. The method of claim 45, wherein the system information comprises a Master Information Block (MIB) and wherein the SFN parameter is comprised in the MIB and the SFN extension parameter is comprised in a block of bits in the system information other than the MIB.

48. The method of claim 45, wherein the system information is comprised in one or more SYSTEM INFORMATION messages, and the SFN extension parameter is comprised in each, a subset, or one of the one or more SYSTEM INFORMATION messages.

49. The method of claim 45, wherein the SFN extension parameter is comprised in a System Information Block type 2 (SIB2) of the system information, which SIB2 comprises a paging configuration parameter; or in System Information Block type 5 or System Information Block type 5bis.

50. The method of claim 45, wherein the SFN extension parameter represents high order bits while the SFN parameter represents low order bits of a total SFN.

51. The method of claim 45, further comprising transmitting at least one of the SFN parameter and the SFN extension parameter to a second radio base station or another network node in the radio communications network.

52. The method of claim 45, further comprising receiving SFN information of a second cell in the radio communications network from a second radio base station and/or one or more user equipments within the cell.

53. The method of claim 52, further comprising transmitting the SFN information of the second cell to the one or more user equipments in the cell, the second radio base station, and/or another network node in the radio communications network.

54. The method of claim 45, further comprising setting the SFN parameter and the SFN extension parameter for the cell.

55. A user equipment capable of configuring a Discontinuous Reception (DRX) cycle at the user equipment, said user equipment is capable of operating in a radio communications network, which radio communications network comprises a radio base station controlling a cell serving the user equipment, wherein the user equipment comprises:
a receiver configured to receive from the radio base station, system information associated with the cell, which system information comprises a System Frame Number (SFN) parameter and an SFN extension parameter extending the SFN parameter; and
a configuring circuit arranged to configure a DRX cycle for the user equipment based on the SFN parameter and the SFN extension parameter.

56. The user equipment of claim 55, wherein the configuring circuit is arranged to configure an inactive period of a paging DRX cycle and/or a cycle length of a connected mode DRX cycle.

57. The user equipment of claim 55, wherein the received system information comprises a Master Information Block (MIB) and wherein the SFN parameter is comprised in the MIB and the SFN extension parameter is comprised in a block in the system information other than the MIB.

58. The user equipment of claim 55, wherein the received system information is comprised in one or more SYSTEM INFORMATION messages, and the SFN extension parameter is comprised in each, a subset or one of the one or more SYSTEM INFORMATION messages.

59. The user equipment of claim 55, wherein the SFN extension parameter is comprised in a System Information Block type 2 (SIB2) of the system information, which SIB2 comprises a paging configuration parameter; or in System Information Block type 5 or System Information Block type 5bis.

60. The user equipment of claim 55, wherein the SFN extension parameter represents high order bits while the SFN parameter represents low order bits of a total SFN.

61. The user equipment of claim 55, wherein the receiver is further configured to receive SFN information of a second cell in the radio communications network from the radio base station or a second radio base station.

62. The user equipment of claim 61, further comprising a reporting circuit configured to report the SFN information of the second cell to the radio base station.

63. A radio base station capable of transmitting system information in a radio communications network, which radio base station is configured to control a cell in the radio communications network, wherein the radio base station comprises:
a transmitter configured to transmit, to one or more user equipments in the cell, system information associated with the cell, which system information comprises a System Frame Number (SFN) parameter and an SFN extension parameter extending the SFN parameter, wherein the SFN parameter and the SFN extension parameter are to be used to configure a Discontinuous Reception (DRX) cycle at the one or more user equipments.

64. A radio base station according to claim 63, wherein the DRX cycle comprises an inactive period of a paging DRX cycle and/or a cycle length of a connected mode DRX cycle.

65. The radio base station of claim 63, wherein the system information comprises a Master Information Block (MIB) and wherein the SFN parameter is comprised in the MIB and the SFN extension parameter is comprised in a block of bits in the system information other than the MIB.

66. The radio base station of claim 63, wherein the system information is comprised in one or more SYSTEM INFORMATION messages, and the SFN extension parameter is comprised in each, a subset, or one of the one or more SYSTEM INFORMATION messages.

67. The radio base station of claim 63, wherein the SFN extension parameter is comprised in a System Information Block type 2 (SIB2) of the system information, which SIB2 comprises a paging configuration parameter; or in System Information Block type 5 or System Information Block type 5 bis .

68. The radio base station of claim 63, wherein the SFN extension parameter represents high order bits while the SFN parameter represents low order bits of a total SFN.

69. The radio base station of claim 63, further comprising an input/output interface configured to transmit at least one of the SFN parameter and the SFN extension parameter to a second radio base station or another network node in the radio communications network.

70. The radio base station of claim 63, further comprising a receiver configured to receive, from one or more user equipments within the cell, SFN information of a second cell in the radio communications network; and/or a input/output interface being configured to receive, from a second radio base station or another network node, SFN information of the second cell in the radio communications network.

71. The radio base station of claim 70, wherein the transmitter is further configured to transmit the SFN information of the second cell to the one or more user equipments in the cell, and/or the input/output interface is configured to transmit the SFN information of the second cell to the second radio base station, or another network node in the radio communications network.

72. The radio base station of claim 63, further comprising a processing circuit configured to set the SFN parameter and the SFN extension parameter for the cell.
